(19) United States
(12) Patent Application Publication
(10) Pub. No.: US 2004/0237396 A1
(43) Pub. Date: Dec. 2, 2004

(54) Germination device for production of sprouts

(76) Inventor: Angel Castillo, Balingen-Erzingen (DE)

Correspondence Address: D. PETER HOCHBERG CO. L.P.A., 1940 EAST 6TH STREET, CLEVELAND, OH, 44114, US

(21) Appl. No.: 10/492,862

(22) PCT Filed: Oct. 11, 2002
(86) PCT No.: PCT/EP02/11418

(30) Foreign Application Priority Data
Oct. 16, 2001 (DE) 101 52 645.8

(51) Int. Cl. A01G 31/00

(52) U.S. Cl. 47/61

(57) ABSTRACT

The invention relates to a germination device for the production of sprouts that comprises at least one, preferably however several, in particular three automatic, time-controlled and intermittently rotatable sprout receiving and germination container (3₁, 3₂, . . . ) that is ventilated vis-à-vis the atmosphere as well as, respectively, an intermittently activatable set-up for spray irrigation (21, 22) of seeds introduced into the container(s) that outlets into the inside of this/there container(s).

By virtue of the invention, generation of a high yield having consistent quality of the most various types of sprouts, even several types at the same time, can be achieved.

### BACKGROUND OF THE INVENTION

1. Field of the Invention

The invention relates to a germination device for the production of sprouts in accordance with a germination device for the production of sprouts, this device having a sprout receiving and germination container, said container being automatically time-controlledly, intermittently rotatable, ventilated, drum-shaped, mounted on a drive shaft and drivable via the drive shaft, and an intermittently activatable set-up for spray irrigation of seeds placed in the container, said set-up outletting into the inside of the container.

2. Description of the Prior Art

Sprouts of many varieties of seeds such as Lucerne, alfalfa, radishes, clover, soy, nearly all types of grain, in total more than 25 types, have long been and are increasingly part of diets aimed at healthy nutrition. On the basis of pre-germination that, depending on the type of seed, can take two to six days at average room temperature and somewhat longer for some types, the vitamins, enzymes and minerals stored in the seeds is pre-broken down so that the human digestive tract and organism can tap into such important trace elements and elements and thus overcome, in particular, deficiencies in a diet that otherwise in many instances would be one-sided. In the kitchens of many sanatoriums, in hospitals with good nutrition, in restaurants, in many cafeterias, and also for an increasing number of nutrition-conscious private persons, sprouts of various types of seeds have become an indispensable part of their diet plan.

Sprouts are often grown in special departments of nurseries on large, sieve-like, perforated trays or tubs stacked over one another using daylight when possible or also using artificial light. In addition, the seeds are soaked, as necessary, after a washing process for a particular amount of time, e.g. roughly eight hours, and are subsequently distributed on the perforated germination receiver, i.e. the trays or tubs, in a more or less thick layer in order to be then moistened with water in more or less regular intervals during the desired germination period of e.g. two to six days. Various moistening and spray systems are known and are in use in this respect. The germinated sprouts are then allowed to drain off and are packed in servings, typically in clear plastic containers, in order to then be brought or sent to the consumers as quickly as possible as “appetizing goods.” Nonetheless, it is not unusual that several days, often up to a week, pass from the production-side supply until the consumption by the nutrition-conscious consumer, i.e. until the goods land on the plate of a consumer. Large sprout cultivation businesses that transport their goods to distributors by the truckload before they are distributed to individual stores, have also begun employing, in order to avoid early spoiling of the sensitive sprout goods, the method of radiation with shortwave, high energy radiation that has become common for many vegetable goods and fruit goods so that the goods retain their fresh appearance for a significantly longer period of time. As a rule, however, the largest portion of the valuable vitamins and enzymes is already degraded or lost through oxidation or other reaction within several days, whence the trusting consumer more or less only consumes shells of roughage.

For consumers who are aware of the described problems regarading the swift degradation of vitamins and enzymes of fresh goods that have been stored for a longer amount of time, germination apparatuses for home use have been available for some time especially for the culturing of sprouts in which a more or less arbitrary, even small amount of sprouts of various types can be raised simultaneously and on-time for desired consumption. A known apparatus of this type consists, essentially, of a stack of perforated germination trays configured on top of one another that is placed in a collection tub for drain water. The pre-soaked seeds placed in the germination trays must then be regularly sprayed with water by the user in as consistent as possible intervals of e.g. four to six hours, for which, in view of its suitability, e.g. a spray bottle is used. The disadvantage of this essentially very simply designed germination device for home use is that, on the one hand, the regular spraying of the germinating goods is forgotten or remains unfulfilled for other reasons such that the germinating seeds dry out when the moistening is interrupted for too long. Moreover, if the individual germination trays are not optimally covered, part of the goods does not germinate at all or germinate at all or germinates at various rates of growth, whence the number of rejects is relatively large. A ratio of 7:1, e.g. in the case of alfalfa, is already considered a good yield in the case of expert moistening.

A time-controlled and intermittently drivable, drum-shaped germination container which is known for the pre-treatment of seeds that are to be planted or transplanted is known from the publication GB 1 382 262, the inner wall of which is provided with rails running in the shape of screws in order to achieve a good mixing of the seeds. The drum-shaped container is mounted on a pipe-shaped drive-shaft, through which water is feedable for spray irrigation of the seeds contained in the wave-shaped container. The publication DE 44 11 226 C1 describes a germination device for sprouts having a vertically configured and likewise drivable drum-shaped container that is divided into individual levels on which the seeds are to be placed. A similar sprout germination device is described in FR 2 779 028 A1. These known sprout germination devices are intended more for the production of larger amounts of shoots. By virtue of costs alone, they are less or not at all suitable for a home production of very small, individually selectable amounts of sprouts.

### SUMMARY OF THE INVENTION

It is object of the invention to provide a germination device for sprouts that, with simple operability, is well suited for homes or small businesses and with which an optimal yield of good quality of sprouts from various seeds or using the same seeds can be reliably achieved in short intervals of e.g. one day fresh and preferably even in small amounts.

A germination apparatus for sprouts in accordance with the invention comprises the features of a sprout receiving and germination container, said container being automatically time-controlledly, intermittently rotatable, ventilated, drum-shaped, designed and mounted on a drive shaft and drivable via the drive shaft, and an intermittently activatable set-up for spray irrigation of seeds placed in the container, said set-up outletting into the inside of the container. Preferred extensions and embodiments of the invention are defined, inter alia, in further dependent claims and are described in further detail below.

Preferably, the sprout receiving and germination container, hereinafter also just container, is designed in the fashion of a rotating drum, i.e. is drum-shaped, and provided with a loading and removal opening. It is mounted on a hollow shaft as a driveshaft, through which the water feeding for spray irrigation of the seeds is effected. Preferably and, as a rule, the hollow shaft supporting and driving the container is horizontally arranged in an operational condition. In this respect, the container is likewise preferably rigidly connected to the hollow shaft only at its drive-side faceplate.

In order, one the one hand, to harvest a plurality of various types of sprouts simultaneously or temporally staggered and/or, on the other hand, to allow, for the same choice of seeds, various, e.g. daily, times of maturity of the sprouts in order to regularly have respectively absolutely fresh sprout goods available, it is particularly advantages to divide the drum-shaped container into several individual container segments that are separated from one another, that are individually loadable and emptiable, that are respectively provided with ventilation openings that are formed via drum segments and that are respectively provided with spray irrigation individually associated therewith. At the same time, it is preferable if the individual container segments are individually removably held on the drive-side faceplate. The fixing and mounting of the container segments on the face side can be achieved via one or more clamping apparatuses or snap mounts. In this respect, a fluid seal between the edges of the container segments and the faceplate is not necessary since the container and/or the container segments are provided with ventilation opening on their circumferential periphery and/or on the face side facing away from the face side that simultaneous allow the draining of surplus water after a respective spray irrigation. In case not all container segments are used simultaneously, it is advantageous that the spray irrigation for the respectively unused container segments can be individually shut off, for instance be closed similar to a water faucet.

As an example, two to three, preferably, however, three container segments are provided. The container and/or container segments are typically made of a transparent plastic so that the user can continuously observe the respective degree of germination or the state of maturity of the sprout production.

The set-up for spray irrigation comprises at least one spray jet that outlets into the inside of the drum-shaped container and whose stream outlet opening/openings is/are oriented such that a spray stream with respect to its main stream direction is/are oriented in an angular region of 20 to 70°, preferably with an orientation of the spray cone of roughly 45° to the drum axis. This applies, mutatis mutandis, for the case where several, e.g. three, container segments are provided. In this case, at least one set-up for spray irrigation is in each container segment, namely preferably a spray jet that outlets therein whose stream outlet opening(s) is (are) oriented such that the respectively delivered spray stream with respect to its main stream direction is oriented in an angular region of roughly 20 to 70°, preferably with an orientation of the spray cone of roughly 45° to the drum axis. The spray jets outletting into the container segments are typically fed through a water distribution chamber into which water can be fed via the hollow shaft with a predetermined pressure. It is advantageous to form the water distribution chamber as a ring chamber centrally mounted to the faceplate, in particular as a ring-shaped hollow flange that is rigidly connected to the faceplate or preferably integrated into the faceplate. The rotatable sprout receiving and germination chamber or chambers are e.g. and in particular held by a support frame formed by a base plate and a vertically extending side face on whose upper free end the hollow shaft is mounted in a plain bearing. A particular advantage thereof is the use of a drip tray fitted to the size of the base plate for receiving the water dripping from the germination container(s) during and after spray irrigation.

The container(s) held by the preferably circular faceplate can be set into rotation via the hollow shaft via an intermittently actuating, preferably automatically controlledly excitable electrical drive, e.g. such that the container(s) is (are) set into a relatively slow rotation around the axis of the hollow shaft every one to eight hours, in particular roughly every four hours for roughly one minute and, in the course thereof simultaneously moistened via the spray irrigation that is then switched on. The expression “relatively slow rotational motion” means, in this case, a rotation value of e.g. 10 rotations/min to 60 rotations/min, preferably from roughly 25 to roughly 40 rotations/min, in particular 30 rotations/min. Experiments carried out over a longer period of time have shown that the rotational speed of the container(s) is to be chosen such that, on the one hand, a good mixing in addition to simultaneous ventilation and moistening is to be ensured, but that also, on the other hand, it is to be ensured that the shoots sprouting from the seeds are not damaged or broken off. The particular advantage of this rotational mixing of the seeds is as follows: The shoots sprouting from the seeds grow, if the seeds remain continuously in the same rest position, more or less vertical to the force of gravity in an upward direction, exploiting free spaced and gaps between those shoots that may lie thereabove. If the sprouting seeds are, contrary thereto, carefully and in temporal intervals of several hours, briefly mixed, then the shoots grow more or less along the outer shell of the seed, which is desired and significantly improves the quality of the sprout product on the one hand and also in particular the yield. Accumulation of heat from the germinating goods, which damages some sensitive sprouts, is thus avoided (important e.g. for radish sprouts) on the one hand. Since the growth of the shoots is always vertical to the force of gravity, curved and thus stable fiber structures develop in the shoots via the intermittent rotation of the germinating goods, which is particularly advantageous e.g. for alfalfa. In this manner, the yield is regularly increased to 10:1 or more in contrast to the conventional culturing method where the seeds poured and layered over one another lay at rest and where, with respect to yield, average values of roughly 7:1 are achieved.

The intermittently excited electrical drive can either and preferably act directly on the hollow shaft, in which case, above all, a step motor drive is conceivable, or the electric drive can act on the face via a planetary gear gear reduction or a worm drive. The electric drive from the container, on the one hand, and the activating of the spray irrigation, on the other hand, is carried out with a time control unit whose activating signals that can be preset with respect to their temporal sequence intermittently switch, on the one hand, the drive for the container or for the container segments on/off and, on the other hand, activate e.g. a magnetic valve, for instance in the case of a mains-supplied pressurized water supply or a pump, to the respect that the germination is designed for “self-sufficiency,” i.e. is provided with a water reservoir tank. The time control unit can be, in the simplest case, a conventionally known timer. Typically, however, a small, electronic time control unit with a selection set-up will be provided that is placed e.g. in a side wall of the support frame or a cut out, separated hollow space of the water container. In turn, in the simplest case, which suffices, however, for the production, in terms of its quality, of a high-value sprout product, the time control only outputs a time control signal for the simultaneous activation of the container drive on the one hand or the activation of the spray irrigation on the other hand. It is possible, however, to design the time control unit such that the temporally sequential excitation of the container drive can be chosen independently from the time sequence and the respective length of the spray irrigation. Comprehensive experiments have shown that the pulse-width ratio of the activation signals for the container drive on the one hand or the spray irrigation on the other hand should be set to small values of 1:60 [min] to 1:360 [min] such that, for example, in the case of a pulse-width ratio of 1:240 [min] the germinating seeds in the container or the containers is rotated every four hours for one minute, i.e. is carefully mixed, wherein the spray irrigation is carried out simultaneously.

It can be advantageous to place a water cleansing filter upstream from the spray irrigation, in particular if the sprout germination apparatus is used at a location where e.g. the only water that is available is strongly contaminated with nitrates or is very calciferous.

To the respect that the “self-sufficient” alternative for the sprout germination device in accordance with the invention is chosen, i.e. having a water tank and, as the case may be, a self-sufficient power supply, two alternatives are currently of primary interest: On the one hand, the water tank can be placed on the so-called dry side, i.e. on the drive side, of the faceplate with good accessibility for filling and/or cleaning. For this solution alternative, one or more surfaces of the water container, in particular the upper covering surface, can be equipped with solar cells. The energy supplied by this solar cell generator is stored in rechargeable batteries and/or accumulators and is then available for the short excitation phases of the container drive and/or the excitation of a pump for the spray irrigation. The entire, yet—as explained—short term power demands lie considerably below 100 W, in particular between 30 to 60 W. Naturally, it is also possible to operate the entire germination apparatus via primary or secondary cells, wherein the entire power supply and time control set-up including battery power supply is housed in a separate chamber on or in the frame or the water container.

The other alternative, in the case of a small footprint for the germination device, is to place the water tank below the drip tray that then preferably acts as a cover for the water tank. Naturally, other positions for the water tank or water container are possible, e.g. even such that the spray irrigation is carried out solely via hydrostatic pressure from a water tank positioned above the germination device. In this case, a pump is naturally dispensable and solely a simple magnetic value on the water container or at the end of a tube connection to the spray jets is necessary.

To the respect that the germination device in accordance with the invention is equipped with several germination chambers as preferably provided, the various operational wishes can be thus fulfilled for the device user without problem. One such operation involves the nutrition-conscious user who prefers only one type of sprout, in particular as an always-fresh ingredient to another meal. This user will individually fill the roughly 1 to 2.5 liter-sized drum segment containers with the pre-soaked, desired seeds in a desired amount at temporal intervals of roughly two days. He/She can likewise, in the case of simultaneous filling of the individual containers, carry out the choice of seeds in accordance with the various germination times of individual types that, for the one type, is only three days, e.g. in the case of grain, beans, oilseeds, and/or in the case of one or more other types is six days, e.g. in the case of alfalfa, radishes. Of course, the amount of fresh sprouts in optimal quality respectively produced day-by-day is individually selectable.

An alternative of the device that was determined in the testing phase of the germination apparatus in accordance with the invention to be advantageous in numerous respects has the following dimensions: total height 40 cm; diameter of the germination drum put together from the individual container segments roughly 33 cm; depth including a separate water tank roughly 40 cm; without the water tank roughly 25 cm. This device type is suitable, due to its convenient size, for private households on the one hand and for small sanatoriums, restaurants, and the like on the other hand. It allows up to roughly 1 kg (or less, of course, depending on the needs of the user) of fresh sprouts to be produced reliably and with a respectively degree of freshness in temporal intervals of e.g. two days.

### DESCRIPTION OF THE DRAWINGS

The invention and advantageous details will be described in exemplary embodiments in further detail below with reference to the figures.

They show:

FIG. 1: The perspective rear view of a sprout germination device with features in accordance with the invention;

FIG. 2: a “self-sufficient” alternative of the sprout germination device of FIG. 1 having a water container pump and a drip tray;

FIG. 3: the sprout germination device of FIG. 2 from the front side, wherein a germination container is removed;

FIG. 4: a drum segment-shaped germination container,

FIG. 5: a preferred alternative embodiment corresponding to the rear-side perspective view of FIG. 2 having a direct electromotor, e.g. step motor drive on a hollow shaft interspersed by the water feed;

FIG. 6: the partial section, side view of the sprout germination device of FIG. 2; and

FIG. 7: the rear view of a “self-sufficient” sprout germination device in accordance with the invention having a space-saving configuration of the water supply container under a water drip tray.

Constructional components corresponding to one another are identified in all the figures by the same reference signs.

### DESCRIPTION OF THE PREFERRED EMBODIMENTS

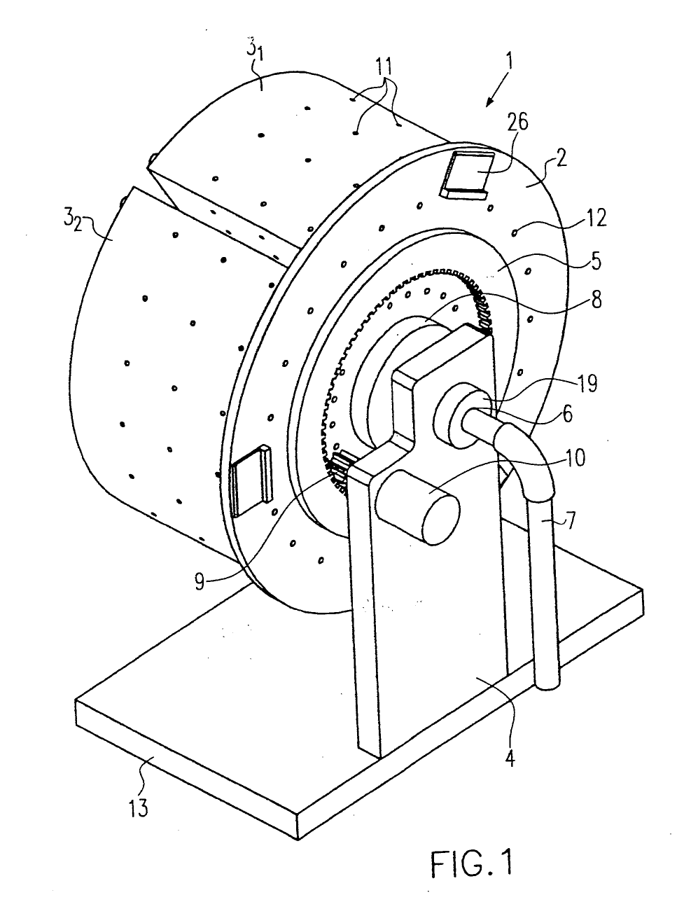

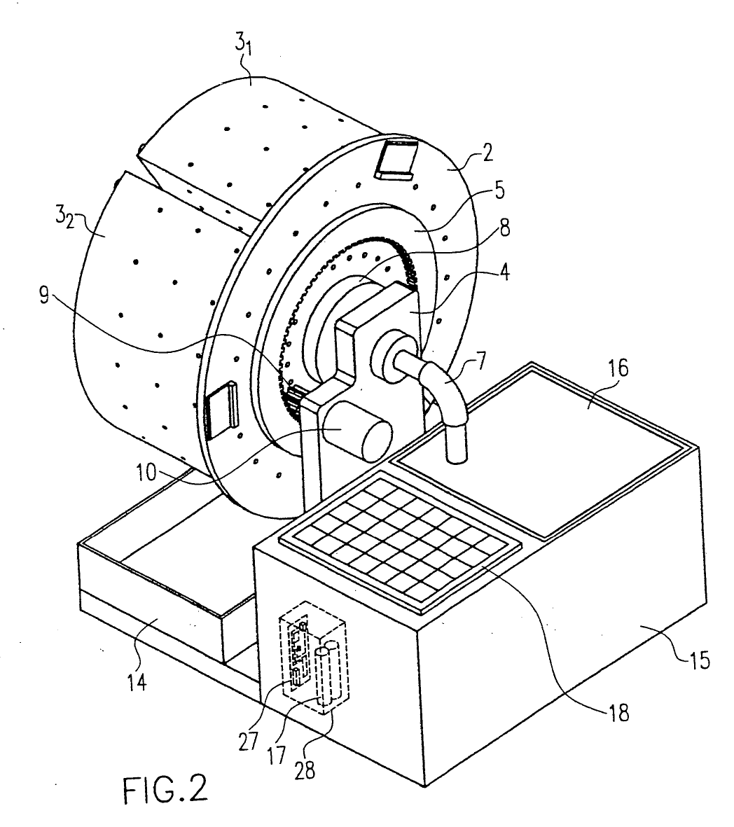

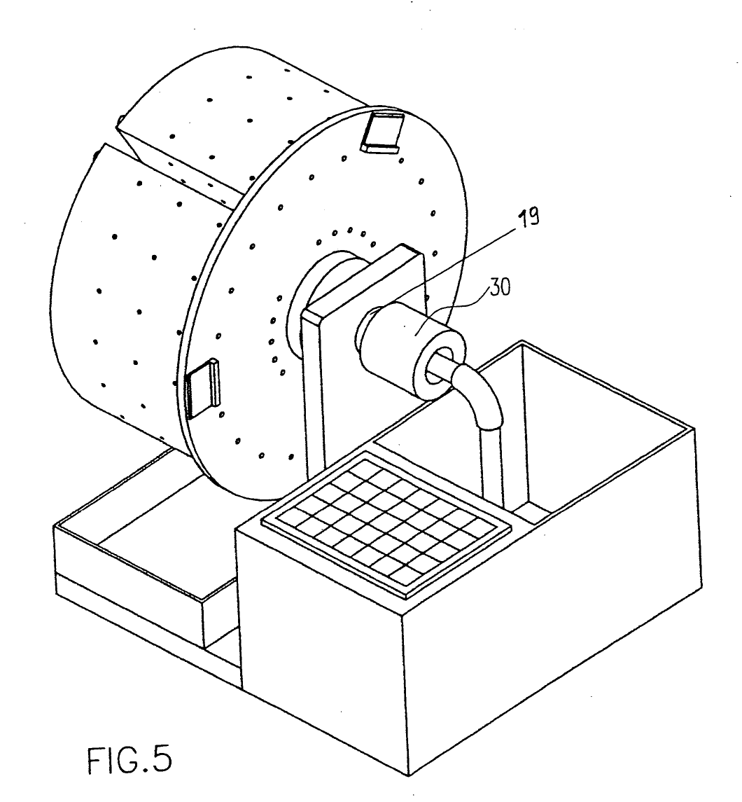

The perspective rear view of FIGS. 1 and 2 of a sprout germination device in accordance with the invention comprises, as an essential constructional component, first of all a drum-shaped container 3 typically manufactured of transparent, shock-resistant plastic, in particular a polycarbonate plastic, said container preferably and typically being divided into several mutually independently loadable and, in particular, preferably into three drum segments 3₁, 3₂, . . . , latter of which is not visible in FIG. 2. The drum segments 3₁, 3₂, . . . are removably or detachably fixed to a preferably circular drive plate marked as faceplate 2, wherein the drum segment side surfaces adjacent to the surface of the faceplate 2 turned away from the observer are open (cf. FIG. 4). The drum segments 3₁, 3₂, . . . are provided with a plurality of small passage openings 11 at least on their outer circumferential walls, preferably however on all cover surfaces, so that on the one hand good ventilation of the seeds placed in the inner chambers of drum segments 3₁, 3₂, . . . occurs, yet on the other hand a dripping of surplus water during and after a spray irrigation operation is ensured. The faceplate 2 can, yet need not, be provided with one or more rings of ventilation openings 12. On the side surface of the faceplate 2 facing the observer, an inwardly toothed planetary drive ring 5 is mounted or preferably formed on the faceplate 2 in centric configuration that meshes with a pinion 9 on the shaft of a small electric drive motor 10. The drive of the faceplate 2 can also be implemented differently, e.g. via a worm drive (not shown). The faceplate 2 sits rotatably on a fixed hollow shaft 19 and is held thereon by means of a plain bearing (not shown). The hollow shaft 19 as well as the motor 10 are held on the upper end of a vertically extending side face 4 of a support frame formed by the side face 4 as well as a base plate 13. The passage 6 of the hollow shaft 19 is interspersed by water supply formed by a tube piece and a tube connection 7 that ends, at the device side, in an annular hollow flange 8, that is centrically configured within the planetary drive ring 5 and is rigidly connected to the faceplate 2. The drum segments 3₁, 3₂ and 3₃ removably fixed to the faceplate 2 can be set into a relatively slow, in particular intermittent rotation by the electromotor 10 via the planetary drive 5, 9 or a worm drive (not shown) including the hollow flange 8. The meshed and rotating drive parts visibly illustrated in the figures are naturally “child-safely” covered in a device ready for operation.

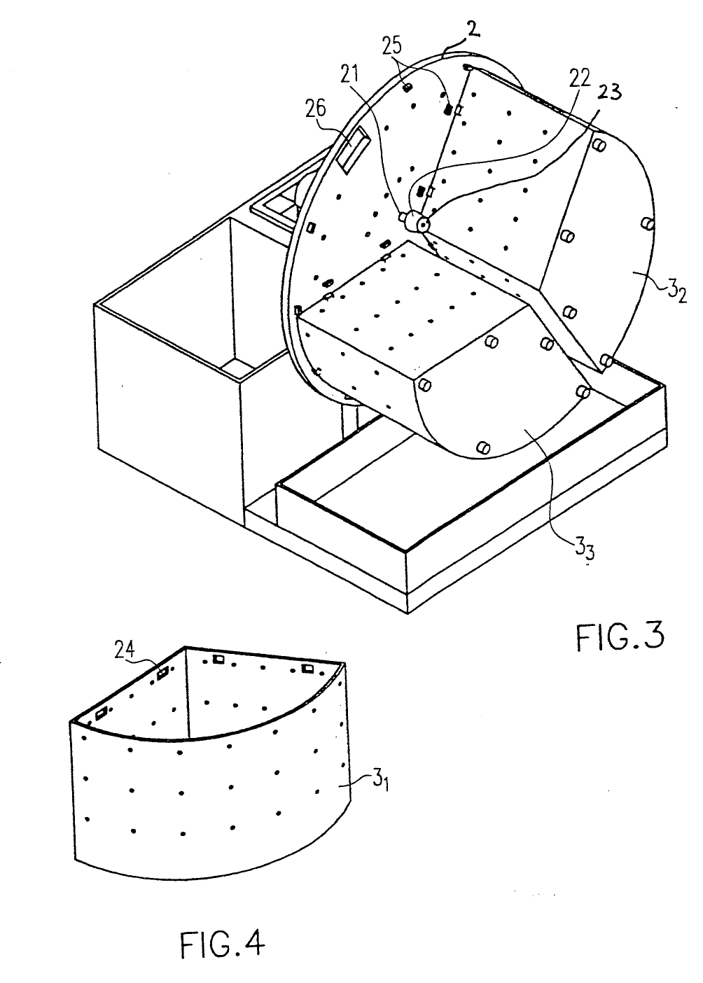

As is recognizable from the front-side perspective depiction of FIG. 3 after removal of the container segment 31 shown in FIG. 4, the faceplate 2 is provided with a plurality of spray irrigation set-ups or water passages 21, i.e. with at least one for each container segment 3₁, 3₂, . . . , respectively, that are in connection with the inner space of the hollow flange 8. The water passages 21 outlet respectively into a spray head 22 that preferably comprises a spray jet 23 at its free end, through which a finely distributed spray moisturization of the seeds placed in the container segments 3₁, 3₂, . . . is carried out. The spray heads 22 are preferably oriented such that the axis of the respective spray cone lies roughly 45° to the drum axis or to the drive axis. The spray heads 22 can be individually closed in case an associated container segment is not loaded. As is recognizable from FIGS. 3 and 4, the drum segment-shaped germination containers 3₁, 3₂, . . . are open on their side surfaces facing the faceplate 2 and are fixed to the faceplate 2 via snap-clamp elements 24, 25 whose corresponding mounting element 26 are formed on the free inner edge of the drum segment-shaped containers 3₁, 3₂ or on corresponding regions of the faceplate 2. Other easily loosened mounts of the drum segmented-shaped germination containers 3₁, 3₂, . . . are also possible.

In the alternative embodiment of the invention of FIG. 1, the water feed for spray irrigation is carried out via e.g. a main water supply, wherein preferably a magnetic valve (not shown) is configured upstream. During a spray irrigation phase, e.g. for one minute every four hours, the magnetic valve is released and the water pressure is thus set such that a good spray moisturization of the seeds contained in the drum-shaped germination containers 3₁, 3₂, . . . is ensured. Simultaneously, yet possibly longer, the electromotor is activated and sets the faceplate 2 and thus the germination container in a relatively slow rotational motion preferably of roughly 25 to roughly 45 rotations/min, in particular of roughly 30 rotations/min.

As can be recognized from FIG. 1 loading openings 26 can be cut away in the faceplate 2, spatially associated with the drum segment-shaped germination containers 3₁, 3₂ that are closable through a one-sidedly hinged snap-lock cover. In this manner, a further loading of the germination containers can be effected as desired. A water collection tray (14) is provided below the germination containers during use of the germination device that is not shown, however, in FIG. 1.

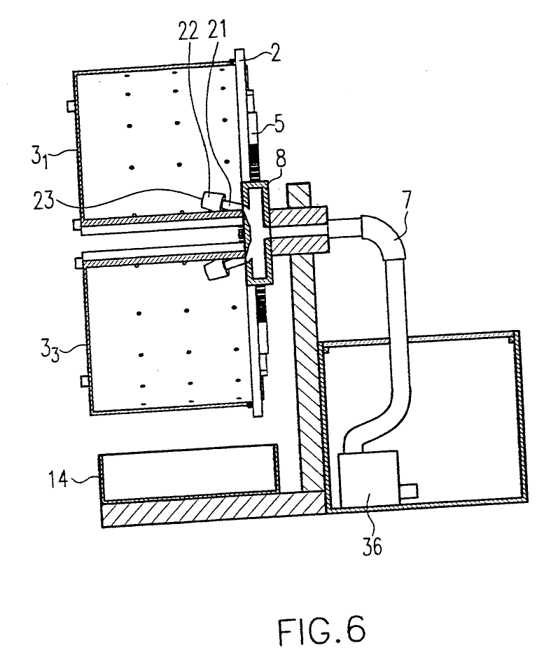

FIG. 2 shows a modified embodiment of the sprout germination device of FIG. 1, wherein the recited water drip tray 14 is provided. This alternative of a sprout germination device in accordance with the invention is termed “self-sufficient” since a separate water supply container 15 is associated therewith. The water container 15 comprises an upwardly tiltable or removable cover 16. A small pump, such as an electric pump 36, schematically hinted at in FIG. 6 is located with the container 15 for allowing a pressurized water supply to the spray irrigation. It is also possible and is provided in an advantageous alternative to use the electric device drive for also directly driving a small pump, e.g. a wing or spiral pump, that acts, in the illustrated example of FIG. 2, as a suction and/or pressure pump. A separate timing unit and driver unit for the electric drive 10 or the pump can be housed in the support frame 4, 13 or, as schematically illustrated in FIG. 2, in a cut away space of the container 15. A driver circuit board 27 and two primary and/or secondary cells 28 are schematically hinted at. In the case of secondary cells, it is possible to recharge these through solar cells 18 provided on the water container 15 such that a sprout germination device in accordance with FIG. 2 can be used totally self-sufficiently.

FIG. 5 shows a schematic depiction of another alternative embodiment corresponding to the depiction of FIG. 2 in which the aforementioned planetary drive 5, 9 is replaced by an electric direct drive 30, e.g. a step motor, that acts, in this case, directly on the now rotatable hollow shaft 19, and that, as the case may be, simultaneously actuates a pump apparatus (not shown). This alternative embodiment with a drive that acts directly on the hollow shaft 19 is preferable over the planetary drive or a worm drive because of its reduced susceptibility to fault or lower possibility of dirtying as well as cheaper production costs (due to lack of the worm gear or planetary drive).

In the partial section depiction of a sprout germination device in accordance with the invention of FIG. 6, the configuration and orientation of the spray heads 22 having spray jets 23 associated with the drum segment-shaped germination containers 3₁, 3₂, . . . is, above all, recognizable having connections 21 open to the inner space of the hollow flange 8. The axes of the spray heads 22 and/or the spray jets 23 stand, in relation to the drum axis 35, in an angular range of 20° to 70° and preferably such that the spray cones ensure as unitary and homogenous moisturization of the seeds contained in the germination containers as possible. This is also a case of a “self-sufficient” alternative of the invention having a separate water container 15 having a schematically illustrated pump 36 that can be plugged onto the water feed 7.

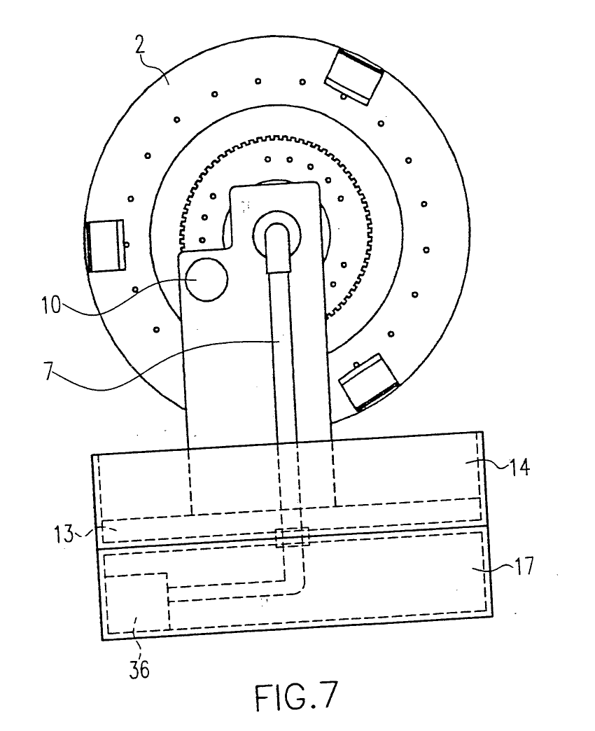

The drive-side schematic side view of FIG. 7, which shows a “self-sufficient” sprout germination device in accordance with the invention corresponding to that of FIG. 2, differs from the latter in that the drip tray 14 situated below the device simultaneously serves as a cover for the water container 15 configured therebelow, whence, in total, a smaller footprint is achieved.

1. (Canceled)

2. Germination device in accordance with claim 31, wherein the container segments are connected to said a drive-side faceplate.

3. Germination device in accordance with claim 2, wherein the container segments are individually removably held on the drive-side faceplate.

4. Germination device in accordance with claim 3, further comprising a clamping or snap mount for holding the container segments to the drive-side faceplate.

5. Germination device in accordance with claim 4, further comprising two to six container segments.

6. Germination device in accordance with claim 31 wherein the germination container segments are fabricated from a transparent plastic.

7. Germination device in accordance with claim 6, wherein the plastic is a polycarbonate plastic.

8. Germination device in accordance with claim 32, wherein the set-up for spray irrigation comprises at least one spray jet outletting into the inside of each container segment, said spray jet having at least one stream outlet opening oriented such that a spray stream, with respect to a main stream direction, is deliverable in an angular range of 20 to 70°, to the drum axis.

9. Germination device in accordance with claim 8, wherein the at least one spray jet outletting into the container segments is connected to a water distribution chamber having water feedable via the hollow shaft at a predeterminable pressure.

10. Germination device in accordance with claim 9, wherein the water distribution chamber is a distribution chamber centrally mounted on the faceplate.

11. Germination device in accordance with claim 8, wherein the at least one spray jet is individually closable.

12. Germination device in accordance with claim 10, wherein the distribution chamber is an annular hollow flange rigidly connectable to the faceplate.

13. Germination device in accordance with claim 9, wherein the distribution chamber is integrally formed in the faceplate.

14. Germination device in accordance with claim 32, further comprising a support frame having a free upper end, said support frame having a base plate and a vertically extending side face; and a plain bearing on said free upper end of said support frame, wherein the hollow shaft is mounted in said plain bearing.

15. Germination device in accordance with claim 14, further comprising a drip tray the size of the container segments, said drip tray being fitted to the base plate for reception of the water draining from the container during and after a spray irrigation phase.

16. Germination device in accordance with claim 32, wherein said apparatus further comprises an intermittently excitable electric drive operatively connected to the faceplate.

17. Germination device in accordance with claim 16, wherein the electric drive comprises a planetary gear gear reduction operatively connected to the face plate for rotating said container.

18. Germination device in accordance with claim 16, wherein the electric drive comprises a worm gear coupled with the faceplate for rotating said container.

19. Germination device in accordance with claim 16, wherein the electric drive comprises a drive motor that directly drives the hollow shaft.

20. Germination device in accordance with claim 19, wherein the drive motor is an electronically controllable step motor.

21. Germination device in accordance with claim 31, further comprising an electric time control unit having predeterminable time sequence activation signals, said signals intermittently switching on and off the apparatus for the container segments and activating the spray irrigation set-up.

22. Germination device in accordance with claim 21, wherein the activating signals occurs simultaneously.

23. Germination device in accordance with claim 22, wherein the activation signal of the electronic time control unit employed for activating the container drive is the same activation signal employed for activating the spray irrigation set-up.

24. Germination device in accordance with claim 21, wherein the activation signals comprise a pulse-width ratio, the pulse-width ratio being adjustable to a value of between about 1:60 [min] to 1:360 [min].

25. Germination device in accordance with claim 21, further comprising a magnetic valve, impinged upon by the electronic time control unit, between the spray irrigation set-up and a pressure-impinged water supply.

26. Germination device in accordance with claim 25, further comprising a water cleansing filter upstream from the spray irrigation set-up.

27. Germination device in accordance with claim 21, further comprising a water container for storing of water for the spray irrigation, and an associated electric pump activatable via the time control unit for generating a water pressure suitable for the spray irrigation set-up.

28. Germination device in accordance with claim 27, wherein the water container is a removable floor-space pedestal for the germination apparatus, the water container having an upper-side cover as a drip tray for surplus water dripping off from the container during and after a spray irrigation phase.

29. Germination device in accordance with claim 27, wherein at least a side surface of the water container has solar cells for self-sufficient power supply of the germination apparatus.

30. Germination device in accordance with claim 5, comprising three container segments.

31. Germination device for the production of sprouts, said germination device comprising:
a sprout receiving and germination drum-shaped, rotatable container, said container including:
ventilating structure for ventilating the container; and
at least two individual, mutually separable, and individually loadable and unloadable container segments, said segments having ventilation and water drain openings and individual associated spray irrigation set-ups;
apparatus for automatically, time-controlledly, and intermittently rotating the container; and
an intermittently activatable set-up for spray irrigation of seeds placed in the container, said set-up outletting into the inside of the container for cooperating with the individually associated set-ups to effect spray irrigation.

32. Germination device in accordance with claim 2, said apparatus further comprising a drive shaft operatively connected to said drive-side faceplate, said drive shaft is a hollow shaft allowing the feeding of water for spray irrigation through the drive shaft, wherein the container segments are connected to said apparatus.
